(19) United States
(12) Patent Application Publication
(10) Pub. No.: US 2026/0147380 A1
(43) Pub. Date: May 28, 2026

(54) HOUSING STRUCTURE

(71) Applicant: Acer Incorporated, New Taipei City (TW)

(72) Inventors: Yi-Mu Chang, New Taipei City (TW); Wen-Chieh Tai, New Taipei City (TW); Chih-Chun Liu, New Taipei City (TW); Tzu-Wei Lin, New Taipei City (TW); Yu-Shih Wang, New Taipei City (TW); Dong-Sheng Wu, New Taipei City (TW)

(73) Assignee: Acer Incorporated, New Taipei City (TW)

(21) Appl. No.: 19/340,860

(22) Filed: Sep. 25, 2025

(30) Foreign Application Priority Data
Nov. 27, 2024 (TW) 113145716

(51) Int. Cl. G06F 1/16

(52) U.S. Cl. CPC G06F 1/1656; G06F 1/1662

(57) ABSTRACT

A housing structure including first housing member, a second housing member, and an auxiliary housing member is provided. The first housing member has a first lateral positioning portion and a positioning hole penetrating the first lateral positioning portion. The second housing member has a second lateral positioning portion disposed as corresponding to the first lateral positioning portion and a positioning post protruding from the second lateral positioning portion. The second housing member is mounted to the first housing member, and the positioning post passes through the positioning hole. The auxiliary housing member is sleeved on the first lateral positioning portion and the second lateral positioning portion and is engaged with the positioning post.

### CROSS-REFERENCE TO RELATED APPLICATION

This application claims the priority benefit of Taiwan application serial no. 113145716, filed on Nov. 27, 2024. The entirety of the above-mentioned patent application is hereby incorporated by reference herein and made a part of this specification.

### BACKGROUND

### Technical Field

The disclosure relates to a housing structure, and in particular relates to a housing structure having a screwless disassembly and assembly design.

### Description of Related Art

A laptop is composed of a display and a body with logical computing capabilities, in which the body is a housing loaded with a circuit board, a central processing unit, a graphics processor, a power source or other electronic components, and the housing is usually assembled from a first housing member and a second housing member. Specifically, the first housing member is provided with multiple screw holes, and the second housing member is provided with multiple screw posts corresponding to the screw holes. By passing multiple screws through the screw holes and locking into the screw posts, the first housing member and the second housing member may be locked and fixed together. However, during the process of disassembling or assembling the housing, the user must use a screwdriver to loosen or tighten the screws, which is time-consuming and labor-intensive.

### SUMMARY

A housing structure that facilitates rapid disassembly or assembly by users is provided in the disclosure.

A housing structure is proposed in the disclosure, in which the housing structure includes a first housing member, a second housing member and, an auxiliary housing member. The first housing member has a first lateral positioning portion and a positioning hole penetrating the first lateral positioning portion. The second housing member has a second lateral positioning portion disposed corresponding to the first lateral positioning portion and a positioning post protruding from the second lateral positioning portion. The second housing member is mounted to the first housing member, and the positioning post passes through the positioning hole. The auxiliary housing member is sleeved on the first lateral positioning portion and the second lateral positioning portion, and is engaged with the positioning post.

Based on the above, the housing structure adopts a screwless disassembly and assembly design, which not only facilitates rapid disassembly or assembly by users, but also eliminates the need for screws, thereby achieving the purpose of reducing manufacturing costs and resource consumption.

In order to make the above-mentioned features and advantages of the disclosure comprehensible, embodiments accompanied with drawings are described in detail below.

### BRIEF DESCRIPTION OF THE DRAWINGS

FIG. 1A is an exploded schematic diagram of a housing structure according to an embodiment of the disclosure.

FIG. 1B is a schematic diagram of mounting and positioning the second housing member in FIG. 1A to the first housing member.

FIG. 1C is a schematic diagram of the auxiliary housing member of FIG. 1B being sleeved on the first housing member and the second housing member.

FIG. 2A is a bottom view schematic diagram of the housing structure of FIG. 1C.

FIG. 2B is an enlarged partial cross-sectional diagram along line segment 2B-2B in FIG. 2A.

### DETAILED DESCRIPTION OF DISCLOSED EMBODIMENTS

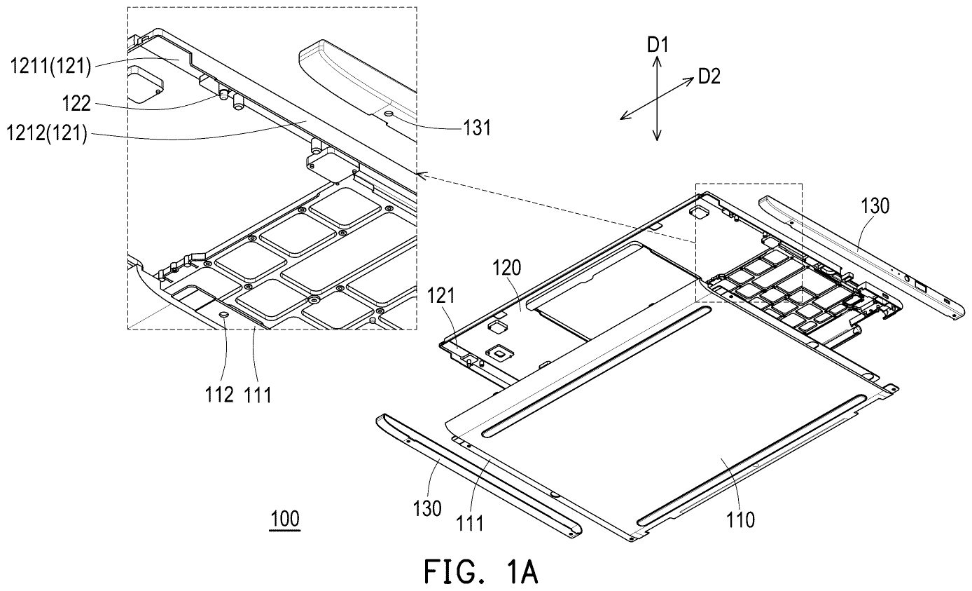

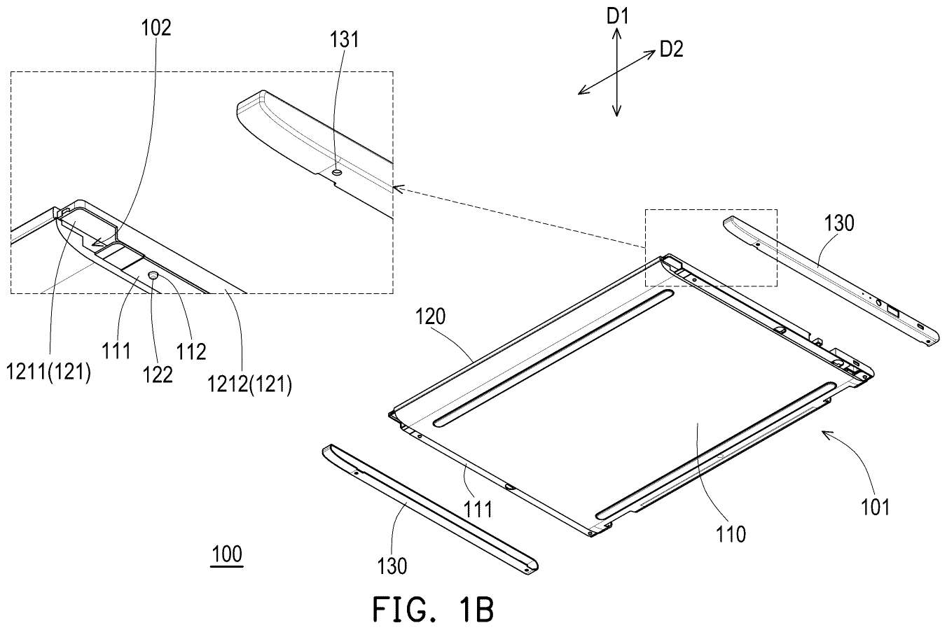

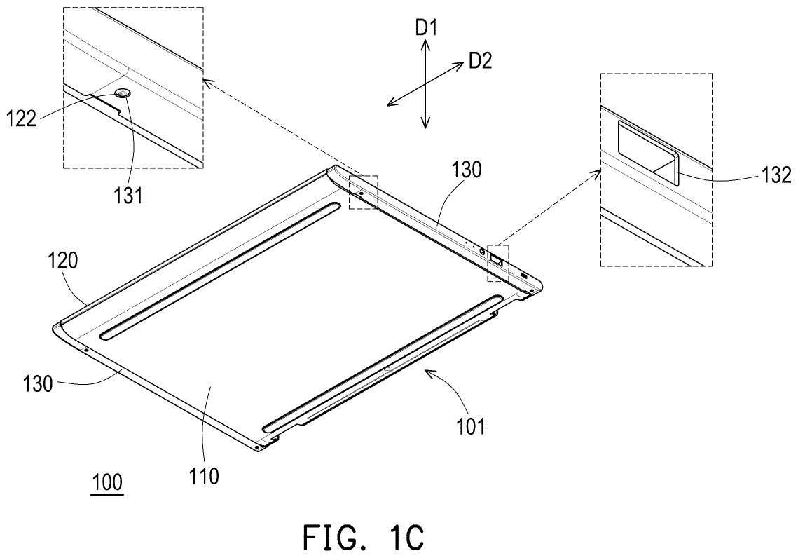

FIG. 1A is an exploded schematic diagram of a housing structure according to an embodiment of the disclosure. FIG. 1B is a schematic diagram of mounting and positioning the second housing member in FIG. 1A to the first housing member. FIG. 1C is a schematic diagram of the auxiliary housing member of FIG. 1B being sleeved on the first housing member and the second housing member. Referring to FIG. 1A, in this embodiment, the housing structure 100 may be applied to laptops, tablets, smartphones, or other electronic devices, and includes a first housing member 110, a second housing member 120, and an auxiliary housing member 130.

In detail, the first housing member 110 has a first lateral positioning portion 111 and a positioning hole 112 penetrating the first lateral positioning portion 111, and the second housing member 120 has a second lateral positioning portion 121 disposed corresponding to the first lateral positioning portion 111 and a positioning post 122 protruding from the second lateral positioning portion 121.

For example, the first housing member 110 has two first lateral positioning portions 111 protruding from two opposite sides of the body of the first housing member 110 respectively. Correspondingly, the second housing member 120 has two second lateral positioning portions 121 protruding from two opposite sides of the body of the second housing member 120 respectively. On the other hand, the number of positioning holes 112 and their positions on the first lateral positioning portion 111 correspond with the number of positioning posts 122 and their positions on the second lateral positioning portion 121, and the number of positioning holes 112 and positioning posts 122 may be adjusted according to actual requirements.

Referring to FIG. 1A to FIG. 1C, in the first disassembly and assembly direction D1, the two first lateral positioning portions 111 are respectively aligned with the two second lateral positioning portions 121, and each set of aligned first lateral positioning portions 111 and second lateral positioning portions 121 is correspondingly provided with an auxiliary housing member 130.

During the assembly process, the user may first mount and position the second housing member 120 to the first housing member 110 along the first disassembly and assembly direction D1 to form the main housing member 101. Then, the two auxiliary housing members 130 are respectively mounted on the two opposite sides of the main housing member 101 along the second disassembly and assembly direction D2 perpendicular to the first disassembly and assembly direction D1, and are respectively sleeved on two sets of aligned first lateral positioning portions 111 and second lateral positioning portions 121 to fix the second housing member 120 to the first housing member 110.

As shown in FIG. 1A and FIG. 1B, during the process of mounting and positioning the second housing member 120 to the first housing member 110, each first lateral positioning portion 111 is initially aligned with its corresponding second lateral positioning portion 121, and it is ensured that each positioning post 122 is aligned with its corresponding positioning hole 112. Then, the second housing member 120 is moved toward the first housing member 110 along the first disassembly and assembly direction D1, alternatively, the first housing member 110 is moved toward the second housing member 120, alternatively, the first housing member 110 and the second housing member 120 are moved closer to each other, so that each positioning post 122 passes through the corresponding positioning hole 112, thereby completing the preliminary positioning between the first housing member 110 and the second housing member 120.

As shown in FIG. 1B, the structural interference between each positioning post 122 and the corresponding positioning hole 112 may prevent the first housing member 110 and the second housing member 120 from being relatively displaced in a direction perpendicular to the first disassembly and assembly direction D1. Then, as shown in FIG. 1C, the two auxiliary housing members 130 are moved to the two opposite sides of the main housing member 101 along the second disassembly and assembly direction D2, and the two auxiliary housing members 130 are respectively sleeved on two sets of aligned first lateral positioning portions 111 and second lateral positioning portions 121.

Furthermore, each auxiliary housing member 130 has auxiliary positioning holes 131, and the number and position of the auxiliary positioning holes 131 may correspond with the number of the positioning posts 122 and their positions on the second lateral positioning portion 121, or correspond with the number of the positioning holes 112 and their positions on the first lateral positioning portion 111. For example, the positioning hole 112 may be a through hole, and the auxiliary positioning hole 131 may be a through hole or a blind hole.

As shown in FIG. 1C, when the two auxiliary housing members 130 are respectively sleeved on two sets of aligned first lateral positioning portions 111 and second lateral positioning portions 121, these positioning posts 122 are inserted into or pass through these auxiliary positioning holes 131 so that the two auxiliary housing members 130 are engaged with the positioning posts 122 to firmly fix the second housing member 120 to the first housing member 110 through the two auxiliary housing members 130, thereby preventing the first housing member 110 and the second housing member 120 from being accidentally separated in a direction parallel to the first disassembly and assembly direction D1.

Correspondingly, during the process of disassembling the housing structure 100, the user only needs to release the engagement relationship between the two auxiliary housing members 130 and the positioning posts 122 to quickly separate the two auxiliary housing members 130 from the first housing member 110 and the second housing member 120 along the second disassembly and assembly direction D2. Subsequently, the second housing member 120 is quickly separated from the first housing member 110 along the first disassembly and assembly direction D1.

Furthermore, the housing structure 100 adopts a screwless disassembly and assembly design, which not only facilitates rapid disassembly or assembly by users, but also eliminates the need for screws, thereby achieving the purpose of reducing manufacturing costs and resource consumption. On the other hand, based on the screwless disassembly and assembly design, the housing structure 100 does not require the installation of screw holes, thereby presenting a minimalist and sleek appearance and texture.

As shown in FIG. 1B and FIG. 1C, after the second housing member 120 is mounted and positioned to the first housing member 110 to form the main housing member 101, an internal space 102 for accommodating a circuit board, a central processing unit, a graphics processor, a power source or other electronic components is formed between the first housing member 110 and the second housing member 120. On the other hand, the auxiliary housing member 130 has one or more lateral openings 132 connected with the internal space 102 to serve as an external opening of the female connector, thereby realizing signal or power transmission. For example, the auxiliary positioning hole 131 and the lateral opening 132 are respectively located on two different surfaces of the auxiliary housing member 130, such as the bottom surface and the side surface respectively.

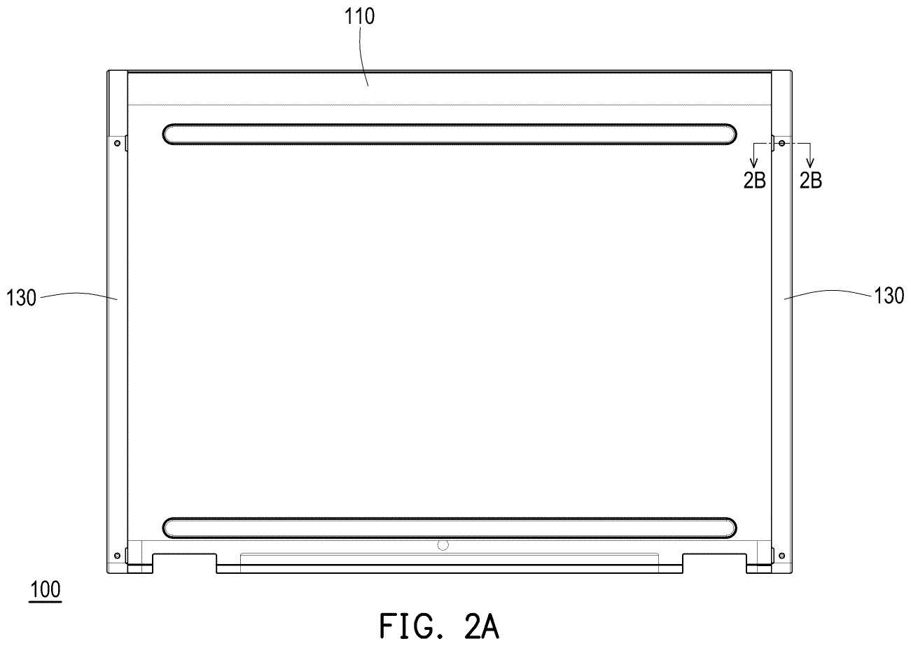

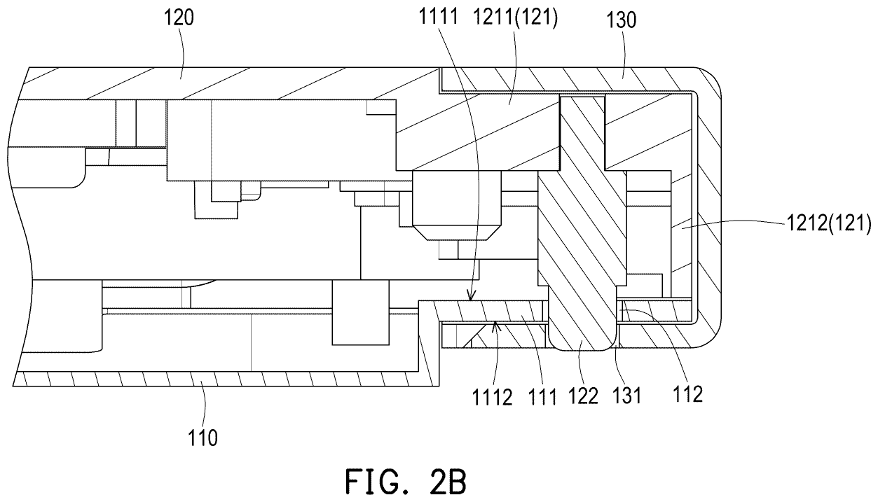

FIG. 2A is a bottom view schematic diagram of the housing structure of FIG. 1C. FIG. 2B is an enlarged partial cross-sectional diagram along line segment 2B-2B in FIG. 2A. Referring to FIG. 2A and FIG. 2B, the second housing member 120 is mounted to the first housing member 110, and the positioning post 122 passes through the positioning hole 112. On the other hand, the auxiliary housing member 130 is sleeved on the first lateral positioning portion 111 and the second lateral positioning portion 121, in which the auxiliary positioning hole 131 is aligned with the positioning hole 112, and the positioning post 122 is inserted into or passes through the auxiliary positioning hole 131 to engage with the auxiliary housing member 130, thereby firmly fixing the second housing member 120 to the first housing member 110 through the auxiliary housing member 130.

In this embodiment, the second lateral positioning portion 121 abuts against the first lateral positioning portion 111 to improve installation stability and structural strength. In detail, the second lateral positioning portion 121 has a first plate portion 1211 parallel to the first lateral positioning portion 111 and a second plate portion 1212 protruding from the side edge of the first plate portion 1211. The second plate portion 1212 extends toward the first lateral positioning portion 111 to abut against the first lateral positioning portion 111.

As shown in FIG. 2B, the positioning post 122 protrudes from the first plate portion 1211 and extends toward the first lateral positioning portion 111. On the other hand, the positioning post 122 and the second plate portion 1212 are substantially perpendicular to the first plate portion 1211, that is, the extending direction of the positioning post 122 is substantially parallel to the extending direction of the second plate portion 1212.

In this embodiment, the first lateral positioning portion 111 has a first surface 1111 in contact with the second plate portion 1212 of the second lateral positioning portion 121 and a second surface 1112 opposite to the first surface 1111. The positioning hole 112 penetrates the first surface 1111 and the second surface 1112, and the positioning post 122 passing through the positioning hole 112 protrudes from the second surface 1112 to be inserted into or through the auxiliary positioning hole 131 aligned with the positioning hole 112.

To sum up, the first housing member is provided with positioning holes, and the second housing member is provided with positioning posts corresponding to the positioning holes. During the process of assembling the housing structure, the user may quickly mount and position the second housing member to the first housing member with the help of the positioning holes and the positioning posts. Then, the auxiliary housing member is sleeved on the first housing member and the second housing member, and the positioning posts passing through the positioning holes are engaged with the auxiliary housing member, to firmly fix the second housing member to the first housing member through the auxiliary housing member. Correspondingly, during the process of disassembling the housing structure, the user only needs to release the engagement relationship between the positioning post and the auxiliary housing member to quickly separate the auxiliary housing member from the first housing member and the second housing member. Subsequently, the second housing member is quickly separated from the first housing member.

In other words, the housing structure adopts a screwless disassembly and assembly design, which not only facilitates rapid disassembly or assembly by users, but also eliminates the need for screws, thereby achieving the purpose of reducing manufacturing costs and resource consumption. On the other hand, based on the screwless disassembly and assembly design, the housing structure does not require the installation of screw holes, thereby presenting a minimalist and sleek appearance and texture.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A housing structure, comprising:
a first housing member, having a first lateral positioning portion and a positioning hole penetrating the first lateral positioning portion;
a second housing member having a second lateral positioning portion disposed corresponding to the first lateral positioning portion and a positioning post protruding from the second lateral positioning portion, wherein the second housing member is mounted to the first housing member, and the positioning post passes through the positioning hole; and
an auxiliary housing member, sleeved on the first lateral positioning portion and the second lateral positioning portion, and engaged with the positioning post.

2. The housing structure according to claim 1, wherein the auxiliary housing member has an auxiliary positioning hole, and the positioning post is inserted into or passes through the auxiliary positioning hole.

3. The housing structure according to claim 1, wherein the second lateral positioning portion abuts against the first lateral positioning portion.

4. The housing structure according to claim 1, wherein the second lateral positioning portion has a first plate portion parallel to the first lateral positioning portion and a second plate portion protruding from the first plate portion, and the second plate portion extends toward the first lateral positioning portion.

5. The housing structure according to claim 4, wherein the second plate portion of the second lateral positioning portion is perpendicular to the first plate portion.

6. The housing structure according to claim 4, wherein the positioning post protrudes from the first plate portion and extends toward the first lateral positioning portion.

7. The housing structure according to claim 6, wherein the positioning post is perpendicular to the first plate portion.

8. The housing structure according to claim 1, wherein the auxiliary housing member has a lateral opening, and the lateral opening is connected to an internal space formed between the first housing member and the second housing member.

9. The housing structure according to claim 1, wherein the first lateral positioning portion has a first surface in contact with the second lateral positioning portion and a second surface opposite to the first surface, the positioning hole penetrates the first surface and the second surface, and the positioning post protrudes from the second surface.

10. The housing structure according to claim 1, wherein a disassembly and assembly direction of the first housing member and the second housing member is perpendicular to a disassembly and assembly direction of the auxiliary housing member.
